(19) United States
(12) Patent Application Publication
(10) Pub. No.: US 2026/0287449 A1
(43) Pub. Date: Sep. 24, 2026

(54) WEARABLE HYBRID SENSOR FOR STRAIN SENSING AND POSITIONING

(71) Applicant: CHONGQING UNIVERSITY OF POSTS AND TELECOMMUNICATIONS, Chongqing (CN)

(72) Inventors: JIUFEI LUO, Chongqing (CN); ZHIDAN LUO, Chongqing (CN); PINGAN YANG, Chongqing (CN); SHENG LU, Chongqing (CN); YUXIN LI, Chongqing (CN); XUEJUN MA, Chongqing (CN); FENGJIA KANG, Chongqing (CN)

(21) Appl. No.: 19/675,955

(22) Filed: May 13, 2026

Related U.S. Application Data
(63) Continuation of application No. PCT/CN2025/136350, filed on Nov. 20, 2025.

(30) Foreign Application Priority Data
Dec. 4, 2024 (CN) 202411771454.9

(51) Int. Cl. G01L 1/22; G06F 3/01

(52) U.S. Cl. CPC G01L 1/2287; G06F 3/014

(57) ABSTRACT

A wearable hybrid sensor for strain sensing and positioning includes a strain sensing module and a position identification module. In a case that the position identification module is not subjected to external force, a sensitive layer and a metal electrode layer are not in contact, and no conductive path is formed; in a case that the sensitive layer receives a pressure from an interphalangeal joint of a finger through a sleeve, a position signal is generated through a microstructured substrate; in a case that the finger is bent, the strain sensing module transmits bending stress to the sensitive layer; and in a case that the sensitive layer is subjected to the bending stress, a resistance value changes to generate a strain signal. The sensor of the present disclosure has simple structure, simple preparation process, high recognition accuracy, and high strain sensing sensitivity.

### CROSS-REFERENCE TO RELATED APPLICATIONS

This application is a continuation of PCT/CN2025/136350, filed on Nov. 20, 2025 and claims priority of Chinese Patent Application No. 202411771454.9, filed on Dec. 4, 2024, the entire contents of which are incorporated herein by reference.

### TECHNICAL FIELD

The present disclosure relates to the field of sensors, and specifically to a wearable hybrid sensor for strain sensing and positioning.

### BACKGROUND

With the rapid development of intelligent technology, according to the performance of high-precision hand motion monitoring system in complex operations and high-precision applications, such as virtual reality (VR), augmented reality (AR), smart gloves and robotics, it cannot provide comprehensive and integrated motion feedback.

The demand in the field is constantly growing. Accurate hand motion capture can not only significantly enhance user experience, but also improve efficiency and accuracy of operation. However, most related hand motion monitoring sensors can only measure a single physical quantity, such as the bending angle of fingers. This limitation restricts the application of the sensor. Human skin contains a variety of sensory units, such as position receptors, pressure receptors, strain receptors and thermal receptors, which work together to enable humans to respond precisely to external stimuli. Position receptors sense vibration and displacement of the skin; pressure receptors detect pressure changes on the skin; strain receptors monitor skin and tissue stretching; and thermal receptors sense temperature changes. The design goal of the biomimetic sensor is to simulate these sensory units to achieve comprehensive monitoring of hand motions, thereby enhancing the integrated functionality and responsiveness of the sensor.

However, related biomimetic strain measurement techniques typically rely on finger bending signals to infer the overall bending angle, which may have analytical errors. Since inverse kinematics calculations may not accurately reflect the angle of each joint, such errors may lead to insufficient operational accuracy in practical applications. Although attempting to integrate multiple functions to obtain bending angle and position information simultaneously, hybrid sensors still face many challenges, including complex circuit arrangement, cumbersome sensor structure, difficult fabrication, low accuracy and signal interference. These problems make the related hybrid sensors difficult to meet the requirements of high-precision monitoring in practical applications.

### SUMMARY

To solve the above technical problems, an objective of the present disclosure is to provide a wearable hybrid sensor for strain sensing and positioning, including: a metal electrode layer, a sensitive layer, an electrically insulating pad, an inert gas gap layer, a first electrode, electrically insulating spacer blocks, a second electrode, lead wires, an insulating package and a sleeve.

The metal electrode layer, the sensitive layer, the electrically insulating pad, the inert gas gap layer, the first electrode, the electrically insulating spacer blocks, and the second electrode jointly constitute a position identification module.

The metal electrode layer includes a metal coating and a coating substrate, and the metal coating is adhered to a surface of the coating substrate.

The sensitive layer includes an electrically conductive sensitive layer and a microstructured substrate, and the electrically conductive sensitive layer is adhered to a surface of the microstructured substrate.

The metal coating is externally connected to the lead wire as an output electrode.

A plurality of electrically insulating blocks are supported between the sensitive layer and the metal electrode layer, and the inert gas is charged to form the inert gas gap layer.

The first electrode and the second electrode are respectively connected to two ends of the electrically insulating pad on a same side.

The electrically insulating pad surrounds a periphery of the sensitive layer and the metal electrode layer, and one end of the first electrode and one end of the second electrode located on a same side, are connected to the sensitive layer.

In a case that the position identification module is not subjected to external force, the sensitive layer and the metal electrode layer are not in contact, and no conductive path is formed; in a case that the sensitive layer receives a pressure from an interphalangeal joint of a finger through the sleeve, the sensitive layer under pressure passes through the inert gas gap layer to contact with the metal electrode layer, a low resistance of the metal coating on the metal electrode layer is contacted with a high resistance of the electrically conductive sensitive layer on the sensitive layer, the first electrode and the output electrode form a conductive path and a position signal is generated through the microstructured substrate.

The sensitive layer, the first electrode and the second electrode jointly constitute a strain sensing module.

The first electrode and the second electrode are bonded to two sides of the sensitive layer.

The first electrode and the second electrode are externally connected to two lead wires as an input electrode and output electrode, respectively.

In a case that the finger is bent, the strain sensing module transmits bending stress to the sensitive layer through the sleeve; and in a case that the sensitive layer is subjected to the bending stress, a resistance value between the first electrode and the second electrode changes to generate a strain signal.

An outer side of the insulating package is connected to the sleeve; and the insulating package wraps the position identification module and the strain sensing module inside.

The beneficial effects of the present disclosure:
1) Compared with a single detection sensor, the hybrid sensor of the present disclosure realizes simultaneous detection of bending strain sensing and positioning signals by using one sensitive layer and three electrodes. The microstructure design of the sensitive layer improves the signal resolution of the sensor, enabling more precise detection and distinction of different signal strengths and reducing coupling interference. The whole sensor mainly realizes sensing through the sensitive layer and the metal electrode layer, and has a stable and simple structure.
2) The sensitive layer of the hybrid sensor of the present disclosure serves as both a high-resistance layer for positioning, and a sensitive layer for bending stress sensing. By integrating the positioning and bending stress sensing functions into the same sensitive layer, the sensor structure is simplified, reducing the volume and complexity of the sensor. The single sensitive layer is able to measure bending stress and cooperate with the metal electrode layer for high-precision positioning, improving the overall efficiency of the sensor.
3) The sensitive layer of the hybrid sensor of the present disclosure adopts a microstructural design to optimize the stress response and serves as a high-resistance layer in the positioning function to ensure accurate positioning. Integrating the stress measurement and positioning functions in one sensitive layer greatly simplifies the structural design of the sensor, which not only reduces the number of required components and production costs, but also simplifies the manufacturing and assembly process.
4) The microstructure of the sensitive layer of the hybrid sensor of the present disclosure adopts a cycas cone-like spiral, and the microstructure is designed as a plurality of microscale spirally arranged units, capable of distinguishing between position compression and bending stress. The structure is designed to produce compression when subjected to pressure. When vertical pressure is applied, the spiral microstructure produces compression deformation along its height direction (perpendicular to the substrate), and the compression is mainly concentrated at the top. Due to the large aspect ratio (10:1) of the structure, compression causes changes in the contact area, resulting in variations in resistance. When the sensor is subjected to bending stress, the spiral scales undergo lateral displacement or rotation at the bending point, causing a change in relative position between scales. The change is different from the compression caused by vertical pressure, but produces tensile deformation on the inner and outer sides of the bending point. Due to the design characteristics of the spiral structure, a resistance change is caused by the bending stress.
5) The hybrid sensor of the present disclosure uses a strain sensing mechanism to measure the bending angle of the entire finger and a sliding rheostat-like principle to confirm the bending of the interphalangeal joint. Through collaborative sensing, the hand motion capture system is simplified and the workload of the back-end processing is reduced.
6) According to the position of the interphalangeal joint, the hybrid sensor of the present disclosure adds blocks on two sides to ensure good support when the sensor is relatively long, ensuring the stability and durability of the sensor structure. After undergoing tensile deformation, the supporting blocks return to the original state in a short time, ensuring the stable performance of the sensor during frequent use.
7) The gap layer of the hybrid sensor of the present disclosure is filled with inert gas to effectively prevent oxidation of internal materials and circuits and prolong the service life of the sensor.

### BRIEF DESCRIPTION OF THE DRAWINGS

FIG. 1 is a front view of a structure of a wearable hybrid sensor for strain sensing and positioning according to the present disclosure;

FIG. 2 is a top view of the structure of the wearable hybrid sensor for strain sensing and positioning according to the present disclosure;

FIG. 3 is a side view of the structure of the wearable hybrid sensor for strain sensing and positioning according to the present disclosure;

FIG. 4 is a schematic diagram of a cycas cone-like spiral microstructure according to the present disclosure;

FIG. 5 is a schematic diagram of positioning of the wearable hybrid sensor for strain sensing and positioning according to the present disclosure; and

FIG. 6 is a schematic diagram of bending stress of the wearable hybrid sensor for strain sensing and positioning according to the present disclosure.

### DETAILED DESCRIPTION

The technical solutions in the embodiments of the present disclosure are described below clearly and completely with reference to the accompanying drawings. Obviously, the described embodiments are merely some, but not all, of the embodiments of the present disclosure. Based on the embodiments of the present disclosure, all other embodiments obtained by those ordinary skilled in the art without creative efforts fall within the scope of protection of the present disclosure.

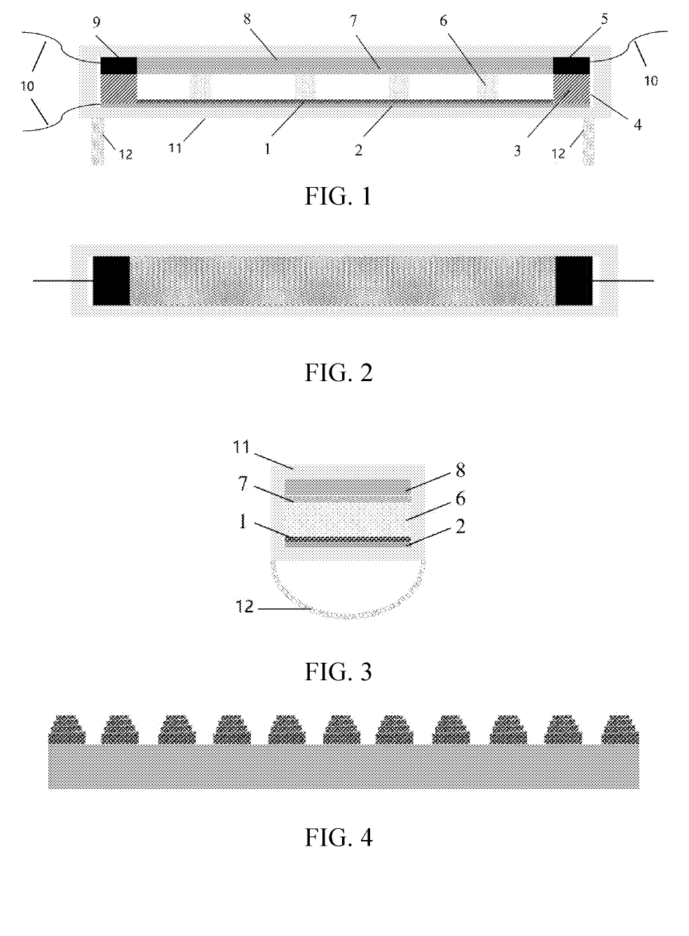

Referring to FIGS. 1-3, the present disclosure provides an embodiment: a wearable hybrid sensor for strain sensing and positioning includes a metal electrode layer, a sensitive layer, an electrically insulating pad 3, an inert gas gap layer 4, a first electrode 5, electrically insulating spacer blocks 6, a second electrode 9, lead wires 10, an insulating package 11 and a sleeve 12;
the metal electrode layer, the sensitive layer, the electrically insulating pad 3, the inert gas gap layer 4, the first electrode 5, the electrically insulating spacer blocks 6, and the second electrode 9 jointly constitute a position identification module;
the metal electrode layer includes a metal coating 1 and a coating substrate 2, and the metal coating 1 is adhered to a surface of the coating substrate 2;
the sensitive layer includes an electrically conductive sensitive layer 7 and a microstructured substrate 8, and the electrically conductive sensitive layer 7 is adhered to a surface of the microstructured substrate 8;
the metal coating 1 is externally connected to one lead wire 10 as an output electrode;
a plurality of electrically insulating blocks 6 are supported between the sensitive layer and the metal electrode layer, and an inert gas is filled to form the inert gas gap layer 4;
the first electrode 5 and the second electrode 9 are respectively connected to two ends of the electrically insulating pad 3 on a same side;
the electrically insulating pad 3 surrounds a periphery of the sensitive layer and the metal electrode layer, and one end of the first electrode 5 and one end of the second electrode 9, located on a same side, are connected to the sensitive layer;

in a case that the position identification module is not subjected to external force, the sensitive layer and the metal electrode layer are not in contact, and no conductive path is formed; and in a case that the sensitive layer receives a pressure from an interphalangeal joint of a finger through the sleeve 12, the sensitive layer under pressure passes through the inert gas gap layer 4 to contact with the metal electrode layer, a low resistance of the metal coating 1 on the metal electrode layer is contacted with a high resistance of the electrically conductive sensitive layer 7 on the sensitive layer, the first electrode and the output electrode form a conductive path and a position signal is generated through the microstructured substrate 8;
the sensitive layer, the first electrode 5 and the second electrode 9 jointly constitute a strain sensing module;
the first electrode 5 and the second electrode 9 are bonded to two sides of the sensitive layer;
the first electrode 5 and the second electrode 9 are externally connected to two lead wires 10 as an input electrode and output electrode, respectively;

in a case that the finger is bent, the strain sensing module transmits bending stress to the sensitive layer through the sleeve 12; and in a case that the sensitive layer is subjected to the bending stress, a resistance value between the first electrode 5 and the second electrode 9 changes to generate a strain signal;
an outer side of the insulating package 11 is connected to the sleeve 12; and the insulating package 11 wraps the position identification module and the strain sensing module inside.

Preferably, a material of the metal coating 1 is one of gold (Au), silver (Ag), and copper (Cu), preferably metallic Cu;
a material of the coating substrate 2 is one of polyimide (PI), polyester (PET) and silicone, preferably silicone; and a layer of conductive metal material is adhered to the coating substrate 2 by one method of physical vapor deposition, chemical vapor deposition spraying and electroplating, preferably physical vapor deposition.

Preferably, a material of the electrically conductive sensitive layer 7 is one or more of metal nanowires, carbon nanotubes, graphene and conductive rubber, preferably carbon nanotubes.

Preferably, as shown in FIG. 4, the microstructured substrate 8 is one of PI, PET, polyethylene (PE), silicone and paper-based material, preferably silicone; and a microstructure of the microstructured substrate is one of a pinecone scale-like structure, a conch shell-like structure, a double-helix spring structure, and a cycas cone-like spiral microstructure, preferably the cycas cone-like spiral microstructure;
the cycas cone-like spiral microstructure has a spiral angle of 20-45°; and first to fourth layers feature diameters of 50-100 μm, 100-150 μm, 100-150 μm, and 200-250 μm, respectively, with a layer height of 20-50 μm and a pitch of 10-25 μm. Preferably, first to fourth layers feature diameters of 80 μm, 120 μm, 170 μm, 220 μm, respectively, with a layer height of 20 μm, 25 μm, 30 μm, 35 μm, and a pitch of 15 μm, 18 μm, 20 μm, 22 μm; and
an arrangement mode of the cycas cone-like spiral microstructure is one of staggered arrangement, gradient arrangement and honeycomb structure, preferably the staggered arrangement.

Preferably, the inert gas filled in the inert gas gap layer 4 is one of nitrogen, helium and argon, preferably helium; and the inert gas gap layer has a thickness of 0.5-2 mm, preferably 2 mm.

Preferably, a material of the electrically insulating pad 3 is one of polytetrafluoroethylene, epoxy resin, and polycarbonate, preferably polytetrafluoroethylene.

Preferably, a material of electrically insulating spacer blocks 6 is one of polyurethane (PU), thermoplastic elastomer, rubber and foam silicone, preferably foam silicone.

Preferably, the electrically insulating pad 3 has a thickness of 1.5-2.5 mm, preferably 2.5 mm.

Preferably, the electrically insulating blocks 6 each have a thickness of 1-2 mm, preferably 2 mm.

The sensitive layer serves both as a high-resistance layer for positioning and a sensitive layer for sensing bending stress. The metal electrode layer serves both as a low-resistance layer for positioning sensing and an output electrode for the third electrode.

The present embodiment provides a method for preparing a wearable hybrid sensor for strain sensing and positioning, including the following steps 1-8.
1) Preparation of Ag nanowire dispersion: Ag nanowire is dispersed in deionized water (or ethanol, acetone, N,N-Dimethylformamide (DMF), etc.) to a standard concentration of 5 mg/mL (in a range of 0.1-5 mg/mL). An ultrasonic oscillator is used, at a frequency of 50 kHz for 10 minutes, to ensure uniform distribution of Ag nanowires.
2) Preparation of silicone substrate for sensitive layer: three-dimensional (3D) printing technology is used to print the substrate mold for sensitive layer, using metallic aluminum as the substrate. The upper surface of the substrate is designed with the cycas cone-like spiral microstructure. A silicone oil release agent is coated inside the mold for facilitating subsequent demolding. The Ag nanowire dispersion is sprayed with a high-precision sprayer, and then the silicone is slowly poured into the mold from one side, allowing the silicone to gradually flow to the other side to reduce bubble formation. The mold with silicone is placed on a vibration table, facilitating the expulsion of bubbles. Subsequently, the mold is allowed to be cured at room temperature for 24 hours, or in an oven at 80℃ for 2 hours. After curing, the substrate is removed from the mold and the surface of the substrate is smoothed out to remove excess material.
3) Electrode connection of sensitive layer: the surface is cleaned with a dust-free cloth, a metallic Cu film is used as an electrode, and conductive adhesive is coated uniformly on two sides of the sensitive layer. The adhesive layer thickness is moderated to ensure good electrical contact. The electrode is aligned and placed on the coated area and allowed to dry naturally. Subsequently, the lead wires are fixed at the bonding position and further fixed with conductive Ag adhesive. The prepared sensitive layer is preserved in a clean storage box.
4) Preparation of metal electrode layer:
   4-1) Preparation of silicone substrate: the silicone substrate is cut using a laser cutting machine with a set power of 20 W, a cutting speed of 10 mm/s and a gas flow rate of 3 L/min. After cutting is completed, cutting residues on the silicone substrate are removed.
   4-2) Metal coating: the silicone substrate obtained in step 6-1 is placed in a magnetron sputtering device, the metal Cu target is cleaned, and the distance between the metal Cu target and the silicone substrate is set to 10 cm. Argon is selected as the sputtering gas, and the parameters are set with a vacuum chamber pressure of 5 x 10⁻⁶ Torr, a sputtering frequency of 100 W, an argon flow rate of 50 sccm, and a sputtering time of 5 minutes. After sputtering, an adhesion of a metal film to the silicone substrate is checked to ensure no peeling.
5) Bonding of lead wires: a conductive Ag adhesive is used to bond lead wires in a section of the metal electrode layer prepared in step 4).
6) Bonding of support blocks: the prepared sensitive layer according to the experimental requirements is bonded with support blocks (with dimensions of 3 mm in length, 3 mm in width, and 2 mm in thickness) on two sides of each knuckle joint.
7) Pre-fixation of insulating package: lower surfaces of the sensitive layer and the metal electrode layer are each adhered to a PET film of the insulating package, the PET film having dimensions of 110 mm in length, 16 mm in width, and 0.5 mm in thickness. An appropriate margin is reserved to prevent packaging failure, and the electrically insulating pad is adhered to the PET film.
8) Packaging sealing: among two reserved needles, one is an air inlet and the other is an air outlet. An inert gas source is connected to the air inlet, and a gas flow valve is slowly opened to allow the inert gas to flow into the gap layer, gradually discharging air in a container. A certain gas flow is maintained to allow the gas flow in the container for a period of time, ensuring that air is completely displaced. Subsequently, two needles are pulled out, remaining holes are sealed with a clamp, and finally a hot air gun at 100℃ is used for sealing treatment. After the seal is completed, the clamp is removed, and excess packaging part is trimmed.

When no external force is applied, as shown in FIG. 1, the sensor remains stationary. When a certain pressure is applied, as shown in FIG. 5, the sensor deforms, and the sensitive layer forms electrical contact with the metal electrode layer. Current flows in from the input electrode and flows out the output electrode through the pressing point. A change in the pressing point results in a different current change in the connected circuit. When the pressing point is close to the metal electrode layer, the resistance value of the loop decreases; conversely, when the pressing point is away from the lead position on the right side of the metal electrode layer, the resistance value increases. This demonstrates that the sensor is able to sense and recognize different pressing points.

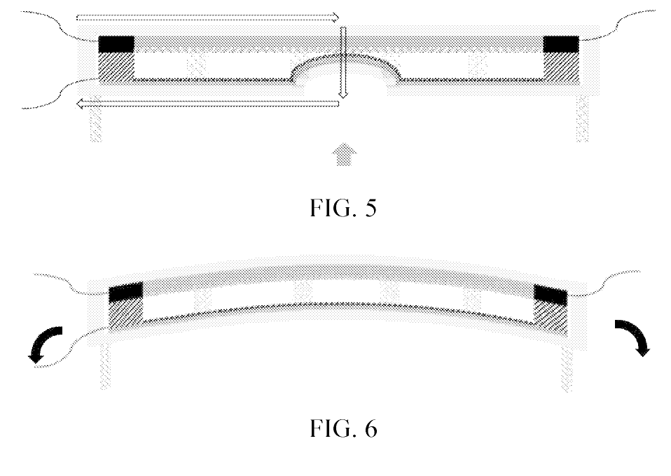

When the sensor is bent, as shown in FIG. 6, the sensitive layer is subjected to bending stress and deforms, resulting in a change in resistance value.

Although the above embodiments of the present disclosure have been shown and described, a person of ordinary skill in the art may make several changes, modifications, substitutions, and variations without departing from the principles and spirit of the present disclosure, and the scope of the present disclosure is limited by the attached claims and equivalents thereof.

1. A wearable hybrid sensor for strain sensing and positioning, comprising: a metal electrode layer, a sensitive layer, an electrically insulating pad (3), an inert gas gap layer (4), a first electrode (5), electrically insulating spacer blocks (6), a second electrode (9), lead wires (10), an insulating package (11) and a sleeve (12), wherein
the metal electrode layer, the sensitive layer, the electrically insulating pad (3), the inert gas gap layer (4), the first electrode (5), the electrically insulating spacer blocks (6), and the second electrode (9) jointly constitute a position identification module;
the metal electrode layer comprises a metal coating (1) and a coating substrate (2), and the metal coating (1) is adhered to a surface of the coating substrate (2);
the sensitive layer comprises an electrically conductive sensitive layer (7) and a microstructured substrate (8), and the electrically conductive sensitive layer (7) is adhered to a surface of the microstructured substrate (8);
the metal coating (1) is externally connected to one lead wire (10) as an output electrode;
a plurality of electrically insulating blocks (6) are supported between the sensitive layer and the metal electrode layer, and an inert gas is filled between the sensitive layer and the metal electrode layer to form the inert gas gap layer (4);
the first electrode (5) and the second electrode (9) are respectively connected to two ends of the electrically insulating pad (3) on a same side;
the electrically insulating pad (3) surrounds a periphery of the sensitive layer and the metal electrode layer, and one end of the first electrode (5) and one end of the second electrode (9), located on a same side, are connected to the sensitive layer;
in a case that the position identification module is not subjected to external force, the sensitive layer and the metal electrode layer are not in contact, and no conductive path is formed; and in a case that the sensitive layer receives a pressure from an interphalangeal joint of a finger through the sleeve (12), the sensitive layer under pressure passes through the inert gas gap layer (4) to contact with the metal electrode layer, a low resistance of the metal coating (1) on the metal electrode layer is contacted with a high resistance of the electrically conductive sensitive layer (7) on the sensitive layer, the first electrode and the output electrodes form a conductive path and a position signal is generated through the microstructured substrate (8);
the sensitive layer, the first electrode (5) and the second electrode (9) jointly constitute a strain sensing module;
the first electrode (5) and the second electrode (9) are bonded to two sides of the sensitive layer;
the first electrode (5) is externally connected to one lead wire (10) as an input electrode; and the second electrode (9) is externally connected to one lead wire (10) as an output electrode corresponding to the second electrode (9);
in a case that the finger is bent, the strain sensing module transmits bending stress to the sensitive layer through the sleeve (12); and in a case that the sensitive layer is subjected to the bending stress, a resistance value between the first electrode (5) and the second electrode (9) changes to generate a strain signal;
an outer side of the insulating package (11) is connected to the sleeve (12); and the insulating package (11) wraps the position identification module and the strain sensing module inside; and
the microstructured substrate is one of polyimide (PI), polyester (PET), polyethylene (PE), silicone and paper-based material, a microstructure of the microstructured substrate is one of a pinecone scale-like structure, a conch shell-like structure, a double-helix spring structure, and a cycas cone-like spiral microstructure, and the microstructure is designed as a plurality of micro-scale spiral arrangement units.

2. The wearable hybrid sensor for strain sensing and positioning according to claim 1, wherein a material of the metal coating (1) is one of gold (Au), silver (Ag) and copper (Cu); and
a material of the coating substrate (2) is one of PI, PET and silicone; and a layer of conductive metal material is adhered to the coating substrate (2) by one method of physical vapor deposition, chemical vapor deposition, spraying and electroplating.

3. The wearable hybrid sensor for strain sensing and positioning according to claim 1, wherein a material of the electrically conductive sensitive layer (7) is one or more of metal nanowires, carbon nanotubes, graphene and conductive rubber.

4. The wearable hybrid sensor for strain sensing and positioning according to claim 1, wherein a microstructure of the microstructured substrate (8) is specifically a cycas cone-like spiral microstructure;
the cycas cone-like spiral microstructure has a spiral angle of 20-45°; and first to fourth layers feature diameters of 50-100 μm, 100-150 μm, 100-150 μm, and 200-250 μm, respectively, with a layer height of 20-50 μm and a pitch of 10-25 μm; and
an arrangement mode of the cycas cone-like spiral microstructure is one of staggered arrangement, gradient arrangement and honeycomb structure.

5. The wearable hybrid sensor for strain sensing and positioning according to claim 1, wherein the inert gas filled in the inert gas gap layer (4) is one of nitrogen, helium and argon; and the inert gas gap layer (4) has a thickness of 0.5-2 mm.

6. The wearable hybrid sensor for strain sensing and positioning according to claim 1, wherein a material of the electrically insulating pad (3) is one of polytetrafluoroethylene, epoxy resin, and polycarbonate.

7. The wearable hybrid sensor for strain sensing and positioning according to claim 1, wherein a material of the electrically insulating spacer blocks (6) is one of polyurethane (PU), thermoplastic elastomer, rubber and foam silicone.

8. The wearable hybrid sensor for strain sensing and positioning according to claim 1, wherein the electrically insulating pad (3) has a thickness of 1.5-2.5 mm.
